(19) United States
(12) Patent Application Publication
(10) Pub. No.: US 2011/0049026 A1
(43) Pub. Date: Mar. 3, 2011

(54) HOLLOW FIBER MEMBRANE MODULE FOR WATER PURIFIER

(75) Inventors: Jae Hee RYU, Seoul (KR); Yong-Cheol Shin, Seoul (KR); Moo-Seok Lee, Seoul (KR)

(73) Assignee: KOLON INDUSTRIES, INC., Kwacheon-si (KR)

(21) Appl. No.: 12/638,155

(22) Filed: Dec. 15, 2009

(30) Foreign Application Priority Data
Aug. 26, 2009 (KR) 10-2009-0078994

(51) Int. Cl. C02F 1/44; B01D 69/08; B01D 63/02; B01D 61/22; B01D 71/68

(52) U.S. Cl. 210/110; 210/321.8

(57) ABSTRACT

A hollow fiber membrane module with good ventilativity is disclosed, which is capable of reducing a time period for completely filling a water space of housing with water introduced through a water inlet by quickly replacing the air in the water space with the water thereby improving the efficiency of water flow.

This application claims the benefit of Korean Patent Application No. 10-2009-0078994 filed on Aug. 26, 2009, which is hereby incorporated by reference for all purposes as if fully set forth herein.

### BACKGROUND OF THE INVENTION

1. Field of the Invention

The present invention relates to a module of a water purifier filtering water, and more particularly to a hollow fiber membrane module with good ventilativity used for a water purifier.

2. Discussion of the Related Art

An industrial development caused various environmental pollutions, especially serious water pollution. The water pollution should be treated with caution since water is used as drinking water at home.

An old water-supplying pipeline and a contaminated water tank in a water reservoir may cause contamination of the drinking water by the proliferation of microorganism, bacilli and bacteria, for example, colon bacilli, typhoid bacilli, and dysentery bacilli. The contaminated water is injurious to the health, and a person who drinks the contaminated water feels unpleasant due to a nasty smell of the contaminated water.

In order to efficiently filter off the contaminants of the drinking water therefrom, a water purifier using ion exchange resin, adsorption filter, or membrane module has been widely used.

The membrane module can be utilized in a wide range owing to its various applications. A separation membrane may be classified into a flat sheet membrane and a hollow fiber membrane. The hollow fiber membrane is a tubular type membrane with a hollow therein. The hollow fiber membrane having a large surface area per unit area is capable of realizing high filtering efficiency. In this respect, a hollow fiber membrane module is generally applied to the water purifier.

The hollow fiber membrane module applied to the water purifier includes a housing provided with a water inlet and a permeate outlet. Inside the housing, there is a potting layer which divides an inner space of the housing into a water space and a permeate space. Also, a bundle of hollow fiber membranes is potted into the potting layer. The bundle of hollow fiber membranes removes polutants from water supplied to the water space of the housing through the water inlet. According as the water passes through the respective hollow fiber membranes, the water is filtrated to be permeate water. Then, the permeate water sequentially passing through the hollow of hollow fiber membrane and the permeate space of the housing is discharged to the external of the housing through the permeate outlet.

The water space of the housing is surrounded and substantially sealed by the housing and the potting layer. Thus, when the water is introduced through the water inlet, air existing in the water space can be moved to the permeate space only through the bundle of hollow fiber membranes, and can be discharged to the external of the housing through the permeate outlet.

That is, until the air existing in the water space is completely moved from the water space to the permeate space through the bundle of hollow fiber membranes, the water space can not be completely filled with the water introduced into the water space through the water inlet. If the water space is not completely filled with the water, it is inevitable to have a limitation in water flow amount of the hollow fiber membrane module.

### SUMMARY OF THE INVENTION

Accordingly, the present invention is directed to a hollow fiber membrane module for a water purifier that substantially obviates one or more of the problems due to limitations and disadvantages of the related art.

An aspect of the present invention is to provide a hollow fiber membrane module with good ventilativity, which is capable of reducing a time period for completely filling a water space of housing with water introduced through a water inlet.

Additional features and aspects of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, there is provided a hollow fiber membrane module comprising a housing including a water inlet and a permeate outlet; a potting layer in the housing, the potting layer dividing an inner space of the housing into a water space and a permeate space; and a bundle of hollow fiber membranes for filtering water in the water space, wherein each of the hollow fiber membranes comprises at least one terminal part potted into the potting layer, the at least one terminal part having an open end such that the hollow fiber membranes are in fluid communication with the permeate space, wherein the bundle of hollow fiber membranes comprises a plurality of hydrophilic hollow fiber membranes and at least one hydrophobic hollow fiber membrane, and wherein a ratio of a surface area of the at least one hydrophobic hollow fiber membrane to an air volume is 0.20 to 1.00 cm⁻¹, the air volume defined as a volume obtained by deducting a volume of the hydrophilic hollow fiber membranes from a volume of the water space.

It is to be understood that both the foregoing general description and the following detailed description are exemplary and explanatory and are intended, to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross sectional view illustrating a hollow fiber membrane module without showing a bundle of hollow fiber membranes according to one embodiment of the present invention;

FIG. 2 is a cross sectional view illustrating a hollow fiber membrane module with a bundle of hollow fiber membranes according to one embodiment of the present invention; and

FIG. 3 is a top face of a potting layer with a bundle of hollow fiber membranes potted thereinto according to one embodiment of the present invention, which is taken by a scanning electron microscope.

### DETAILED DESCRIPTION OF THE ILLUSTRATED EMBODIMENTS

Reference will now be made in detail to an embodiment of the present invention, example of which is illustrated in the accompanying drawings.

Hereinafter, a hollow fiber membrane module for a water purifier according to the present invention will be described with respect to the accompanying drawings.

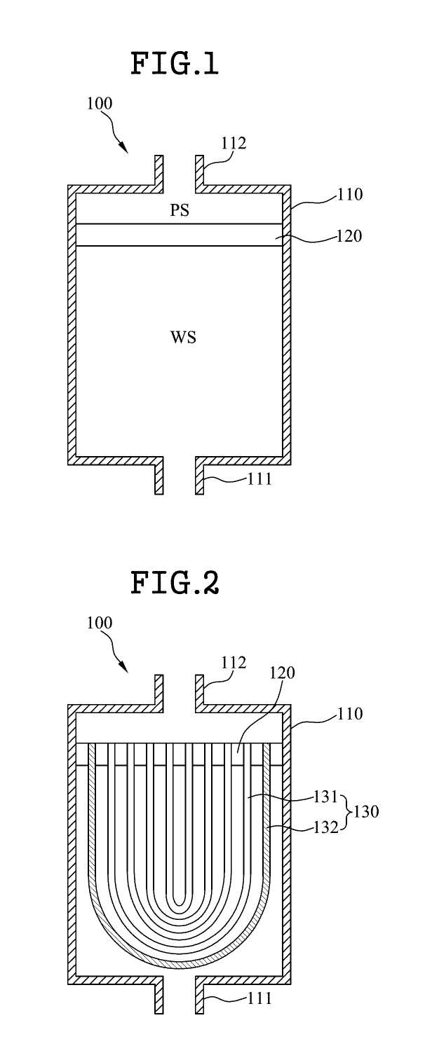

FIG. 1 is a cross sectional view illustrating a hollow fiber membrane module without showing a bundle of hollow fiber membranes according to one embodiment of the present invention; and FIG. 2 is a cross sectional view illustrating a hollow fiber membrane module with a bundle of hollow fiber membranes according to one embodiment of the present invention.

According to one embodiment of the present invention, a hollow fiber membrane module 100 includes a bundle 130 of hollow fiber membranes therein, wherein each of the hollow fiber membranes included in the bundle 130 is formed in a tube shape with a hollow therein for enabling permeate water to pass through each hollow fiber membrane from its external surface to its internal surface, or from its internal surface to its external surface.

At least one end of the bundle 130 of hollow fiber membranes is potted into a potting portion. The potting portion may be formed of thermosetting resin, for example, epoxy resin, urethane resin, or silicon rubber. Selectively, the thermosetting resin may be mixed with filler such as silica, carbon black, or carbon fluoride so as to enhance strength of the potting portion and simultaneously reduce setting shrinkage of the potting portion.

Then, a predetermined portion of the potting portion is cut so as to open the hollow at the one end of the bundle 130 of hollow fiber membranes. As a result, each of the hollow fiber membranes included in the bundle 130 has at least one terminal part potted into a potting layer 120, and the at least one terminal part is provided with an open end.

According to one embodiment of the present invention, as shown in FIGS. 1 and 2, the other terminal part of each hollow fiber membrane is potted into the potting layer 120 so that the bundle 130 of the hollow fiber membranes is entirely bent to ‘U’ shape.

Although not shown, according to another embodiment of the present invention, only the one terminal part of each hollow fiber membrane may be potted into the potting layer 120, whereby the bundle 130 of hollow fiber membranes may be entirely formed in T shape. In this case, the other terminal part of each hollow fiber membrane may be sealed by the thermosetting resin.

The potting layer 120 with the bundle 130 of hollow fiber membranes potted thereinto is fixedly adhered to an inner surface of a housing 110 by a sealant. The housing 110 includes a water inlet 111 and a permeate outlet 112. The water inlet 111 and the permeate outlet 112 may confront each other.

The potting layer 120 fixedly adhered to the inner surface of the housing 110 by the sealant divides the inner space of the housing 110 into a water space (WS) and a permeate space (PS). Through the open end of the bundle 130 of hollow fiber membranes, the bundle 130 of hollow fiber membranes potted into the potting layer 120 is in fluid communication with the permeate space (PS).

The bundle 130 of hollow fiber membranes removes polutants from water introduced into the water space (WS) through the water inlet 111. Then, permeate water permeating through the hollow fiber membranes passes through the hollow and the permeate space (PS) in sequence, and is then discharged to the external of the housing 110 through the permeate outlet 112. Since the water space (WS) and the permeate space (PS) are physically divided by the potting layer 120, it is possible to prevent the permeate water permeating through the bundle 130 of hollow fiber membranes and flowing into the permeate space (PS) through the open end of the bundle 130 of hollow fiber membranes from being mixed with the water introduced into the water space (WS) through the water inlet 111.

Optionally, the hollow fiber membrane module 100 according to the present invention may further include non-woven fabric (not shown) for protecting the bundle 130 of hollow fiber membranes.

When the water is introduced into the inside of the hollow fiber membrane module 100 through the water inlet 111, since the water space (WS) of the housing 110 is surrounded and substantially sealed by the housing 110 and the potting layer 120, air having existed in the water space (WS) can be moved to the permeate space (PS) only through the bundle 130 of hollow fiber membranes and discharged to the external of the hollow fiber membrane module 100 through the permeate outlet 112. That is, until the air existing in the water space (WS) is completely moved from the water space (WS) to the permeate space (PS) through the bundle 130 of hollow fiber membranes, the water space (WS) can not be completely filled with the water introduced into the water space (WS) through the water inlet 111. If the water space (WS) cannot be completely filled with the water, it is inevitable to have a limitation in the flux of the hollow fiber membrane module 100.

Accordingly, the initial flux of the hollow fiber membrane module 100 depends on ventilativity of the bundle 130 of hollow fiber membranes, that is, how fast the bundle 130 of hollow fiber membranes can pass the air existing in the water space (WS) therethrough.

A method of measuring the ventilativity in the bundle 130 of hollow fiber membranes according to the present invention will be explained as follows.

First, the air is supplied to the water space (WS) through the water inlet 111 with the permeate outlet 112 closed until the air pressure rises up to 0.15 Kgf/cm². Then, the permeate outlet 112 is opened and the air-pressure falloff time of each module 100 is measured. The air-pressure falloff time is a time taken for air pressure inside the water space (WS) to fall off to 0.01 Kgf/cm². The shorter the air-pressure falloff time is the greater ventilativity of the bundle 130 of the hollow fiber membranes is.

Even though there was a water purifier manufacturer's demand for a hollow fiber membrane module capable of satisfying air-pressure falloff time below 15 seconds, no hollow fiber membrane module manufacturer could satisfy such demand. However, the hollow fiber membrane module according to the present invention enables to satisfy the air-pressure falloff time below 15 seconds. For this, the bundle 130 of hollow fiber membranes according to the present invention includes at least one hydrophobic hollow fiber membrane 132 as well as a plurality of hydrophilic hollow fiber membranes 131 so as to satisfy the flux required in a wafer-purifier filter.

According to one embodiment of the present invention, the ratio of a surface area of at least one hydrophobic hollow fiber membrane 132 to an air volume is 0.20 to 1.00 cm⁻¹, wherein the air volume is defined as a volume obtained by deducting a volume of the hydrophilic hollow fiber membranes 131 from the volume of the water space (WS). If it is below 0.20 cm⁻¹, it is difficult to satisfy the air-pressure falloff time below 15 seconds. In the meantime, if it is above 1.00 cm⁻¹, the ventilativity in the bundle 130 of hollow fiber membranes is improved insignificantly and a manufacturing cost is increased largely.

Each of the plurality of hydrophilic hollow fiber membranes 131 and at least one hydrophobic hollow fiber membrane 132 has a length of 300 to 2000 mm and an external diameter of 0.1 to 2 mm. Preferably, a volume of the bundle 130 of hollow fiber membranes occupies 30 to 60% of the water space (WS), but not necessarily. If the volume of the bundle 130 of hollow fiber membranes is above 60%, an amount of water introduced into the inside of the water space (WS) through the water inlet 111 is limited so that the water flow amount of the hollow fiber membrane module 100 is reduced. In the meantime, if the volume of the bundle 130 of hollow fiber membranes is below 30%, it is difficult to satisfy the water flow amount required in the water purifier filter.

The plurality of hydrophilic hollow fiber membranes 131 may be formed of polysulfone or polyethersulfone.

The hydrophobic hollow fiber membrane 132 may be formed of polyolefin resin including polyethylene. Also, the hydrophobic hollow fiber membrane 132 has a pore with an average diameter of 0.1 to 0.5 μm. The average diameter of the pore and porosity in the hydrophobic hollow fiber membrane 132 can be adjustable according to the conditions of melt-spinning and drawing processes carried out when manufacturing the hydrophobic hollow fiber membrane 132, which might affect a function of module with ventilativity. That is, if the average diameter of the pore is less than 0.1 μm, lots of hydrophobic membranes have to be provided due to the deteriorated ventilativity. In the meantime, if the average diameter of the pore is more than 0.5 μm, the pore with the large diameter can not filter the polutants, that is, the polutants may pass therethrough.

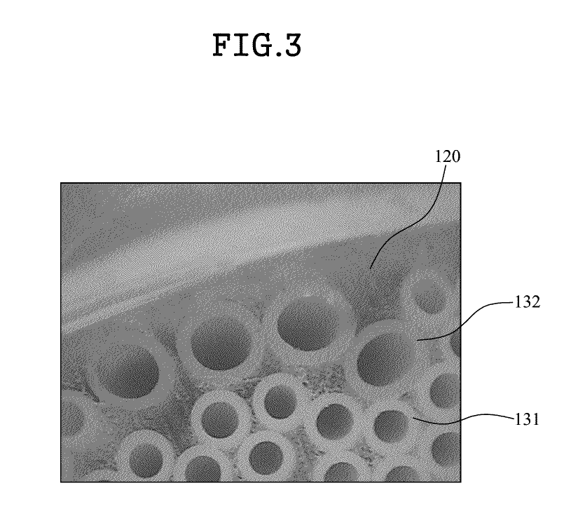

According to one embodiment of the present invention, as shown in FIG. 3, both terminal parts of the at least one hydrophobic hollow fiber membrane 132 are potted into the potting layer 120 in such a way that the at least one hydrophobic hollow fiber membrane 132 is outermost-positioned among the bundle 130 of hollow fiber membranes. Since the air exists mainly in the predetermined space between the housing 110 and the bundle 130 of hollow fiber membranes, the hydrophobic hollow fiber membrane 132 is positioned at the outermost portion of the bundle 130 of hollow fiber membranes so as to improve the ventilativity of the hollow fiber membrane module 100.

Hereinafter, various embodiments and comparative examples will be described as follows, but the scope of the present invention is not limited to the following embodiments and comparative examples.

### Embodiment 1

A U-shaped hollow fiber membrane module is manufactured by using polysulfone hollow fiber membranes and four polyethylene hollow fiber membranes. In this case, the four polyethylene hollow fiber membranes are positioned along the outermost portion of the bundle of hollow fiber membranes, and a volume of a water space (WS) in the hollow fiber membrane module is 40 cm².

### Embodiments 2 to 6 and Comparative Examples 1 to 3

Except that the number of polyethylene hollow fiber membranes used for manufacturing the hollow fiber membrane module is changed as shown in the following Table 1, hollow fiber membrane modules are manufactured by the same conditions and method as the aforementioned Embodiment 1.

TABLE 1

| | The number of polyethylene |
|---|---|
| | hollow fiber membranes |
| | used for manufacturing the |
| Classification | hollow fiber membrane module |
| Embodiment 2 | 2 |
| Embodiment 3 | 3 |
| Embodiment 4 | 5 |
| Embodiment 5 | 7 |
| Embodiment 6 | 8 |
| Comparative example 1 | 0 |
| Comparative example 2 | 1 |
| Comparative example 3 | 9 |

An air volume, a surface area of polyethylene hollow fiber membrane, and a ventilativity are measured in each of the hollow fiber membrane modules manufactured by the Embodiments 1 to 6 and Comparative examples 1 to 3 as follows.

Measuring Air Volume

The air volume is measured in the Comparative example 1 of the hollow fiber membrane module without the polyethylene hollow fiber membrane.

The water is supplied until completely filling the water space (WS) including the completely-dried polysulfone hollow fiber membranes provided therein. Under such circumstance, the amount of water supplied to completely fill the hollow fiber membrane module of the Comparative example 1 is measured. As a result, the air volume is 20 ce.

Except that the respective hollow fiber membrane modules manufactured by the Embodiments 1 to 6 and Comparative examples 2 and 3 are provided with the polyethylene hollow fiber membrane, they are similar to the hollow fiber membrane module of the Comparative example 1. Thus, it is considered that the air volume defined as the volume obtained by deducting the volume of the polysulfone hollow fiber membranes from the water space (WS) is identical in the respective hollow fiber membrane modules manufactured according to the Embodiments 1 to 6 and Comparative examples 1 to 3.

Measuring Total Surface Area of Polyethylene Hollow Fiber Membrane

The total surface area of polyethylene hollow fiber membranes can be measured by the following equation 1 using the average external diameter and average length of the polyethylene hollow fiber membranes.

S=D×π×L×N [Equation 1]

wherein S, D, L, and N represent the total surface area, average external diameter, average length, and number of the polyethylene hollow fiber membranes respectively.

Measuring Ventilativity

The water is supplied to the manufactured hollow fiber membrane modules in such a way that the water flows therethrough under the pressure of 1 Kgf/cn². Then, the air is supplied to the water space (WS) through the water inlet with the permeate outlet closed until the air pressure rises up to 0.15 Kgf/cm². Then, the permeate outlet is opened and the air-pressure falloff time of each module is measured. The air-pressure falloff time is a time taken for air pressure inside the water space to fall off to 0.01 Kgf/cm². The air-pressure falloff time is measured three times for each of the Embodiments 1 to 6 and Comparative examples 1 to 3, and the average of the measured air-pressure falloff time is calculated.

The following table 2 shows the air volume, the surface area of polyethylene hollow fiber membranes, and the ventilativity measured in the respective hollow fiber membrane modules.

TABLE 2

| | | Total surface area | Ratio of total surface | | | | |
|---|---|---|---|---|---|---|---|
| | Air | of polyethylene | area of polyethylene | Ventilativity | | | |
| | volume | hollow fiber | hollow fiber membrane | (air-pressure falloff time period) (sec.) | | | |
| Classification | (cm³) | membrane (cm²) | to air volume (cm⁻¹) | 1^{st} | 2^{nd} | 3^{rd} | Average |
| Embodiment 1 | 20 | 8.98 | 0.45 | 5.55 | 5.07 | 6.01 | 5.54 |
| Embodiment 2 | 20 | 4.49 | 0.22 | 11.87 | 10.19 | 9.77 | 10.61 |
| Embodiment 3 | 20 | 6.74 | 0.34 | 7.41 | 6.95 | 7.24 | 7.20 |
| Embodiment 4 | 20 | 11.23 | 0.56 | 4.51 | 4.16 | 4.38 | 4.35 |
| Embodiment 5 | 20 | 15.72 | 0.79 | 3.16 | 3.01 | 3.46 | 3.21 |
| Embodiment 6 | 20 | 17.96 | 0.90 | 2.24 | 2.34 | 2.33 | 2.30 |
| Comparative | 20 | 0 | 0 | 96.00 | 97.00 | 87.00 | 93.33 |
| example 1 | | | | | | | |
| Comparative | 20 | 2.25 | 0.11 | 25.25 | 24.52 | 25.29 | 25.02 |
| example 2 | | | | | | | |
| Comparative | 20 | 20.21 | 1.01 | 2.14 | 2.29 | 2.31 | 2.25 |
| example 3 | | | | | | | |

As known from the above Table 2, in case of the Comparative examples 1 and 2 which have the ratio of the surface area of polyethylene hollow fiber membrane to the air volume is below 0.20 cm⁻¹, it is incapable of satisfying the air-pressure falloff time below 15 seconds, which is required by the water purifier manufacturer. In comparison with the ventilativity in the Comparative example 6 which has the ratio of 0.90 cm⁻¹, the ventilativity in the Comparative example 3 which has the ratio above 1.00 cm⁻¹ is improved insignificantly.

Accordingly, the hollow fiber membrane module according to the present invention can reduce the time period for completely filling the water space of housing with the water introduced through the water inlet, to thereby increase the initial water-flow amount of the hollow fiber membrane module.

When the water-filtering is stopped, the water remaining in the water space of the housing is replaced with the air quickly so that it is possible to prevent the water contamination in the housing thereby extending the lifetime of hollow fiber membrane.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A hollow fiber membrane module comprising:
a housing including a water inlet and a permeate outlet;
a potting layer in the housing, the potting layer dividing an inner space of the housing into a water space and a permeate space; and
a bundle of hollow fiber membranes for filtering water in the water space,
wherein each of the hollow fiber membranes comprises at least one terminal part potted into the potting layer, the at least one terminal part having an open end such that the hollow fiber membranes are in fluid communication with the permeate space,
wherein the bundle of hollow fiber membranes comprises a plurality of hydrophilic hollow fiber membranes and at least one hydrophobic hollow fiber membrane, and
wherein a ratio of a surface area of the at least one hydrophobic hollow fiber membrane to an air volume is 0.20 to 1.00 cm⁻¹, the air volume defined as a volume obtained by deducting a volume of the hydrophilic hollow fiber membranes from a volume of the water space.

2. The hollow fiber membrane module of claim 1, wherein a volume of the bundle of hollow fiber membranes occupies 30 to 60% of the water space.

3. The hollow fiber membrane module of claim 1, wherein a pore of the at least one hydrophobic hollow fiber membrane has an average diameter of 0.1 to 0.5 μm.

4. The hollow fiber membrane module of claim 1, wherein the plurality of hydrophilic hollow fiber membranes are formed of polysulfone or polyethersulfone.

5. The hollow fiber membrane module of claim 1, wherein the at least one hydrophobic hollow fiber membrane is formed of polyolefin resin.

6. The hollow fiber membrane module of claim 1, wherein both terminal parts of the at least one hydrophobic hollow fiber membrane are potted into the potting layer.

7. The hollow fiber membrane module of claim 6, wherein the at least one hydrophobic hollow fiber membrane is outermost-positioned among the bundle of hollow fiber membranes.

8. The hollow fiber membrane module of claim 1, wherein an air-pressure falloff time is no more than 15 seconds, the air-pressure falloff time being a time taken for air pressure inside the water space to fall off to 0.01 Kgf/cm² after air is supplied to the water space through the water inlet with the permeate outlet closed until the air pressure rises up to 0.15 Kgf/cm² and then the permeate outlet is opened.
